(19) United States
(12) Patent Application Publication
(10) Pub. No.: US 2024/0419756 A1
(43) Pub. Date: Dec. 19, 2024

(54) NEURAL PARTIAL DIFFERENTIAL EQUATION SOLUTION REFINER

(71) Applicant: Microsoft Technology Licensing, LLC, Redmond, WA (US)

(72) Inventors: Johannes BRANDSTETTER, Amsterdam (NL); Phillip Lippe, Amsterdam (NL); Richard E. Turner, Cambridge (GB); Bastiaan Sjouke Veeling, Amsterdam (NL); Paris Perdikaris, Philadelphia, PA (US)

(21) Appl. No.: 18/211,492

(22) Filed: Jun. 19, 2023

(51) Int. Cl. G06F 17/13

(52) U.S. Cl. CPC G06F 17/13

(57) ABSTRACT

Generally discussed herein are devices, systems, and methods for training a partial differential equation (PDE) solver. A method can include training a neural network (NN) operator to estimate a partial differential equation (PDE) solution by in a first iteration, predicting, by the NN operator, an initial value for the PDE solution, in a subsequent iteration, adding noise to the initial value, in the subsequent iteration, estimating, by the NN operator, the noise resulting in predicted noise, determining a difference between the initial value and the predicted noise resulting in a refined value, and updating parameters of the NN operator based a difference between the refined value and a corresponding ground truth for the PDE.

### BACKGROUND

Time-dependent partial differential equations (PDEs) are ubiquitous in science and engineering. Recently, mostly due to the high computational cost of traditional solution techniques, deep neural network (DNN (based surrogates have gained increased interest. The practical utility of such neural PDE solvers relies on their ability to provide accurate, stable predictions over long time horizons, which is a notoriously hard problem.

In recent years, mostly due to a rapidly growing interest in modeling PDEs, deep neural network (DNN) based PDE surrogates have gained significant momentum as a more computationally efficient solution methodology. Recent approaches can be broadly classified into three categories: (i) neural approaches that approximate the solution function of the underlying PDE; (ii) hybrid approaches, where neural networks (NNs) either augment numerical solvers or replace parts of them; (iii) NN approaches in which the learned evolution neural operator maps the current state to a future state of the system. Approaches (i) have had great success in modeling inverse and high-dimensional problems, whereas approaches (ii) and (iii) have started to advance fluid and weather modeling in two and three dimensions. These problems are usually described by complex time dependent PDEs. Solving this class of PDEs over long time horizons presents fundamental challenges.

Conventional numerical methods for solving PDEs suffer accumulating approximation effects, which, in the temporal solution step, can be counteracted by implicit methods. Neural PDE solvers similarly struggle with the effects of accumulating noise, an inevitable consequence of autoregressively propagating the solutions of the underlying PDEs over time. Another critique of neural PDE solvers is that, besides very few exceptions, they lack convergence guarantees and predictive uncertainty modeling, i.e., estimates of how much to trust the predictions. Whereas the former is in general notoriously difficult to establish in the context of deep learning, the latter links to recent advances in probabilistic neural modeling, and, thus, opens the door for new families of uncertainty-aware neural PDE solvers. In summary, current time-dependent neural PDE solvers suffer from problems in long-term accuracy, long-term stability, and the ability to quantify predictive uncertainty.

### SUMMARY

A method, device, or a machine-readable medium for training a partial differential equation (PDE) solver are provided. A method can include training a neural network (NN) operator to estimate a partial differential equation (PDE) solution. Training the NN operator can include, in a first iteration, predicting, by the NN operator, an initial value for the PDE solution. Training the NN operator can include, in a subsequent iteration, adding noise to the initial value. Training the NN operator can include, in the subsequent iteration, estimating, by the NN operator, the noise resulting in predicted noise. Training the NN operator can include, determining a difference between the initial value and the predicted noise resulting in a refined value. Training the NN operator can include, updating parameters of the NN operator based a difference between the refined value and a corresponding ground truth for the PDE.

There can be multiple subsequent iterations and for each subsequent iteration training the NN operator can include one or more of adding noise to the initial value and predicting, by the NN operator, the noise resulting in predicted noise, determining a difference between the initial value and the predicted noise resulting in a refined value, or updating parameters of the NN based a difference between the refined value and a corresponding ground truth for the PDE. Training the NN operator can include reducing a standard deviation of the noise between consecutive iterations. The NN operator can include a U-Net.

The PDE can model behavior of a fluid, weather, or electricity, or a simulatable physical phenomenon. The noise conforms to a Gaussian or other statistical distribution. Each subsequent iteration can include one or more of: adding noise to the refined value resulting in a noisy refined value, predicting, by the NN operator and based on the noisy refined value, the noise resulting in predicted noise, determining a difference between the noisy refined value and the predicted noise resulting in a further refined value, or updating parameters of the NN based a difference between the further refined value and a corresponding ground truth for the PDE.

A system can include processing circuitry, a memory, and/or a user interface. The processing circuitry can be configured to receive a partial differential equation (PDE) solver previously iteratively trained by adding respectively iteratively reduced noise added to input of the PDE solver, estimating, by the PDE solver, the noise, and altering parameters of the PDE solver based on the estimated noise. The processing circuitry can be configured to receive data indicating a PDE to be estimated. The processing circuitry can be configured to operate the PDE solver based on the received data. The processing circuitry can be configured to receive a PDE solution estimate from the PDE solver. The memory can be configured to receive the PDE solution estimate from the processing circuitry and store the PDE solution estimate. The PDE solver can be trained by the method previously discussed.

A machine-readable medium or device can be configured to implement the method.

### BRIEF DESCRIPTION OF DRAWINGS

FIG. 1 illustrates, by way of example, a diagram of an embodiment of a system for neural solver training.

FIG. 2 illustrates, by way of example, a diagram of a trajectory with predicted rollouts for three trajectories, a ground truth, PDE-Refiner, and MSE Training.

FIG. 3 illustrates, by way of example, a diagram of frequency spectrum over a spatial dimension of the ground truth data and one-step predictions.

FIG. 4 illustrates, by way of example, a diagram of errors in terms of absolute error and relative error (relative in terms of ground truth amplitude).

FIG. 5 illustrates, by way of example, a bar graph of correlation time for a variety of PDE solvers.

FIG. 6 illustrates, by way of example, graphs of amplitude versus wavenumber for a variety of refinement steps of PDE-Refiner, ground truth, and MSE training.

FIG. 7 illustrates, by way of example, respective graphs of high-correlation times for PDE-refiner and MSE training versus time and high-correlation time versus cross-correlation time for PDE-refiner.

FIG. 8 illustrates, by way of example, respective graphs of average amplitude versus wavenumber and high-correlation time versus viscosity.

FIG. 9 is a block diagram of an example of an environment including a system for NN training.

FIG. 10 illustrates, by way of example, a block diagram of an embodiment of a method for training a PDE solver that includes a neural operator.

FIG. 11 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Embodiments regard extending a rollout time for which neural network (NN) partial differential equation (PDE) solvers are accurate. Rollout time is the duration of the estimate of PDE solution. Embodiments extend the rollout accuracy by focusing on dominant frequencies in the PDE solution and then refining less dominant frequencies in the PDE solution. Embodiments can add noise to an estimate and refine the estimate with noise of lower and lower amplitude in further iterations. This iterative addition of noise makes the PDE solver focus on less dominant frequencies in the PDE solver and ultimately increases the rollout time for which the PDE solution is accurate.

A large-scale analysis of common temporal rollout strategies is discussed. The discussion identifies the neglect of non-dominant spatial frequency information, often associated with high frequencies in partial differential equation (PDE) solutions. The neglect of the non-dominant spatial frequency information is a pitfall that limits stable, accurate rollout performance. Based on these insights, embodiments provide a novel model class that enables more accurate modeling of all frequency components via a multi-step refinement process. Embodiments, sometimes called PDE-Refine, are validated on challenging benchmarks of complex fluid dynamics, demonstrating stable and accurate rollouts that consistently outperform state-of-the-art models, including neural, numerical, and hybrid neural-numerical architectures. PDE-Refiner enables an accurate and efficient assessment of predictive uncertainty of a model, allowing one to estimate when the surrogate becomes inaccurate.

An analysis of simple autoregressive unrolling with varying history input, the pushforward trick, invariance preservation, and the Markov Neural Operator is presented. Temporal modeling by state-of-the-art neural operators, such as modern U-Nets and Fourier Neural Operators (FNOs) was tested. The testing identified a shared pitfall in all these unrolling schemes: neural solvers consistently neglect components of the spatial frequency spectrum that have low amplitude. Although these frequencies have minimal immediate impact, they still impact long-term dynamics, ultimately resulting in a noticeable decline in rollout performance. Based on these insights, PDE-Refiner aims to remove the pitfall. PDE-Refiner is a novel model class that uses an iterative refinement process to obtain accurate predictions over the whole frequency spectrum. This is achieved by an adapted (e.g., Gaussian) denoising step that forces the network to focus on information from all frequency components equally at different amplitude levels. Experiments demonstrate the effectiveness of PDE-Refiner on solving the 1D Kuramoto-Sivashinsky (KS) equation and the 2D Kolmogorov flow, a variant of the incompressible Navier-Stokes flow. On both PDEs, PDE-Refiner models the frequency spectrum much more accurately than the baselines, leading to a significant gain in accurate rollout time.

The discussion of PDE-Refiner focuses on, but is not limited to, time-dependent PDEs in one temporal dimension, i.e., t∈[0, T], and possibly multiple spatial dimensions, i.e., X=[x₁, x₂, . . . , xₘ]∈X. Time-dependent PDEs relate solutions u(t, x): [0, T]×X→ [symbol] and respective derivatives for all points in the domain, where u⁰(x) are initial conditions at time t=0 and B[u](t, x)=0 are boundary conditions with boundary operator B when x lies on the boundary ∂X of the domain. Such PDEs can be written in the form of Equation 1:

$${u}_{t} = F ( t , x , u , {u}_{x} , {u}_{xx} , … ) , \qquad ( 1 )$$

where the notation uₜ is shorthand for the partial derivative ∂u/∂t, while uₓ, uₓₓ, . . . denote the partial derivatives ∂u/∂x, ∂²u/∂x² and so on. Operator learning relates solutions u: X→ [symbol] ⁿ, u′: X′ → [symbol] ⁿ′ defined on different domains X∈ [symbol] ^{m}, X′∈ [symbol] ^{m}′ via operators G: G: (u∈U)→(u′∈U′), where U and U′ are the spaces of u and u′, respectively. For time-dependent PDEs, an evolution operator can be used to compute the solution at time t+Δt from time t as Equation 2:

$$u ( t + Δ t ) = Gt ( Δ t , u ( t ) ) , \qquad ( 2 )$$

where Gt: [symbol] _{>0}× [symbol] ⁿ→ [symbol] ⁿ is the temporal update. To obtain predictions over long time horizons, a temporal operator can either be directly trained for large Δt or recursively applied with smaller time intervals. In practice, the predictions of learned operators deteriorate for large Δt, while autoregressive approaches are found to perform substantially better.

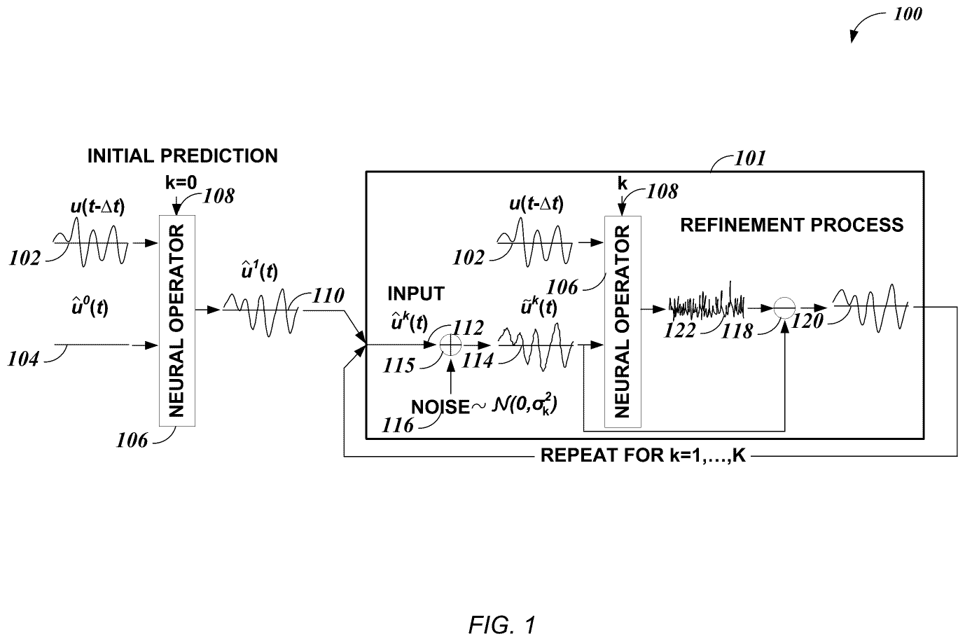

FIG. 1 illustrates, by way of example, a diagram of an embodiment of a system 100 for neural solver training. The system 100 is sometimes called a PDE refiner. The system 100 as illustrated includes a refinement process 101 that refines a prediction made by a neural operator 106. The neural operator 106 is trained to provide output that varies based on input value k 108. The system 100 allows for accurate modeling of the solution to a PDE across all frequencies. The system 100 looks at a prediction 112 from the neural operator 106 multiple times and, in an iterative manner, improves the prediction 112.

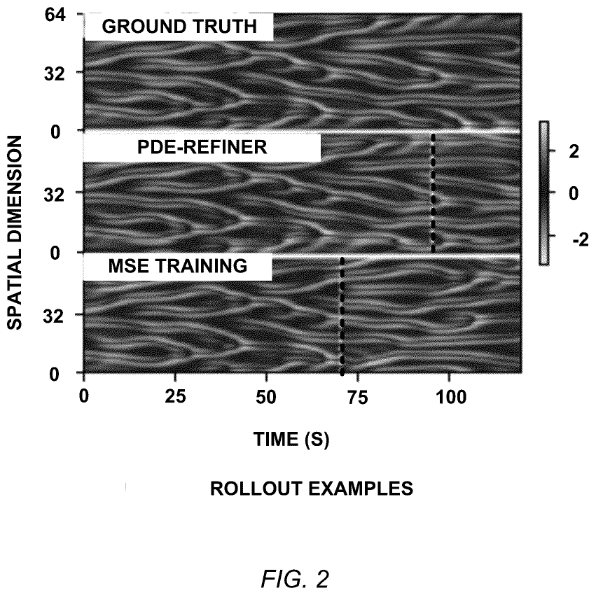

The system 100 includes a neural operator 106 (“NO”) with three inputs: output of previous time step(s) 102 (u(t−Δt)), a refinement step index 108 (k∈[0, . . . , K]), and the current prediction 112 of the neural operator 106 û^{k}(t). The current prediction 112 is taken as an initial prediction 110 at k=0 and a subsequent prediction 120 for k>0. At the first step k=0, the system 100 can use an objective that sets an initial estimate 104 ûₒ(t)=0 and predicting u(t): [symbol] ⁰(u, t)=∥u(t)−NO(û⁰(t), u(t−Δt), 0)∥₂². As discussed previously, this [symbol] prediction will focus on only the frequencies that dominate the input. To improve this prediction, a simple approach would be to train the neural operator 106 to take its own predictions 112 as inputs and output its (normalized) error to the ground truth. However, such a training process has several drawbacks. Firstly, as seen in FIGS. 2-4, the dominating frequencies in the data also dominate in the error, thus forcing the neural operator 106 to focus on the same frequencies again. Such an approach also leads to considerable overfitting and the neural operator 106 does not generalize. Instead, the system 100 implements the refinement process 101 as a denoising objective. At each refinement step k≥1, low-amplitude information of an earlier prediction is removed by applying noise 116, e.g., adding Gaussian noise by adder 115, to the input 112 û^{k}(t) at refinement step resulting in noisy input 114 for k: ũ^{k}(t)=û^{k}(t)+σₖ∈^{k}, ∈^{k}˜N(0, 1). An objective of the neural operator 106 can be to predict this noise 116 ∈^{k} and use the prediction 122 \hat{∈}^{k} to denoise its input: û^{k+1}(t)=ũ^{k}(t)−σₖ \hat{∈}^{k} by subtracting, by subtractor 118, the noise prediction 122 from the noisy input 114. By decreasing the noise standard deviation σₖ over refinement steps, the system 100 focuses on varying amplitude levels. The first steps k∈{0,1} ensure that high-amplitude information is captured accurately, and the later steps k>1 focus on low-amplitude information, typically corresponding to the non-dominant frequencies. Generally, an exponential decrease, σₖ=σₘᵢₙ^{k/K}, with σₘᵢₙ being the minimum noise standard deviation, works well. The value of σₘᵢₙ can be chosen based on the frequency spectrum of the given data. For example, for the KS equation, one can use σₘᵢₙ²=2*10⁻⁷.

The neural operator 106 can be trained by denoising ground truth data at different refinement steps in Equation 4:

$${L}^{k} ( u , t ) = {E}_{{∈}^{k} \sim N ( 0 , 1 )} [ {‖ {∈}_{k} - NO ( u ( t ) + {σ}_{k} {∈}_{k} , u ( t - Δ t ) , k ) ‖}_{2}^{2} \qquad ( 4 )$$

By using ground truth samples in the refinement process during training, the neural operator 106 learns to focus on predicting information with a magnitude below the noise level σₖ and ignore potentially larger errors that, during inference, could have occurred in previous steps. To train all refinement steps equally well, one can uniformly sample k 108 for each training example: L(u, t)=E_{k˜N(0,K)}[L^{k}(u, t)].

At inference time, the neural operator 106 predicts a solution u(t) 120 from u(t−Δt) 102 by performing the K refinement steps of the refinement process 101, where the prediction of a refinement step is sequentially used as the input 112 to the next step. While the process 101 allows for any noise distribution, independent Gaussian noise has the property that it is uniform across frequencies. Therefore, adding Gaussian noise removes information equally for all frequencies, while also creating a prediction target that focuses on all frequencies equally. The system 100 even improves on low frequencies with small amplitudes.

Time-dependent PDEs have the challenges of obtaining long, accurate rollouts for autoregressive neural PDE solvers. A working example of the 1D KS equation is provided. The KS equation is a fourth-order nonlinear PDE, known for its rich dynamical characteristics and chaotic behavior. The KS equation is defined as Equation 3:

$${u}_{t} + {uu}_{x} + {u}_{xx} + {vu}_{xxxx} = 0 , \qquad ( 3 )$$

where v is a viscosity parameter that is commonly set to v=1. The nonlinear term uuₓ and the fourth-order derivative uₓₓₓₓ make the PDE a challenging objective for traditional solvers. Experiments aim to solve this equation for all x and t on a domain [0, L] with periodic boundary conditions u(0, t)=u(L, t) and an initial condition u(x, 0)=u₀(x). The input space is discretized uniformly on a grid of Nₓ spatial points and Nₜ time steps. To solve this equation, the neural operator 106, denoted by NO, is then trained to predict a solution u(x, t)=u(t) given one or multiple previous solutions u(t−Δt) with time step Δt, e.g. u(t)=NO(u(t−Δt)). Longer trajectory predictions are obtained by feeding the predictions back into the solver, i.e., predicting u(t+Δt) from the previous prediction u(t) via u(t+Δt)=NO(û(t)). This process is “unrolling the model” or “rollout”. A goal can be to obtain a neural solver that maintains predictions close to the ground truth for as long as possible.

A most common objective used for training neural solvers is the one-step Mean-Squared Error (MSE) loss: LMSE=∥(t)−NO(u(t−Δt))∥². By minimizing this one-step MSE, the model learns to replicate the PDE's dynamics, accurately predicting the next step. However, as one rolls out the model for longer trajectories, the error propagates over time until the predictions start to differ significantly from the ground truth.

FIG. 2 illustrates, by way of example, a diagram of a trajectory with predicted rollouts for three trajectories, a ground truth, PDE-Refiner, and MSE Training. The vertical, dotted line indicates a time about when a Pearson correlation between ground truth and a corresponding prediction drops below 0.9. PDE-Refiner maintains an accurate rollout for longer than the MSE model. In FIG. 2 the MSE solver is already accurate for 70 seconds, so one might argue that minimizing the one-step MSE is sufficient for achieving long stable rollouts. Yet, the limitations of this approach become apparent when examining the frequency spectrum across the spatial dimension of the ground truth data and resulting predictions.

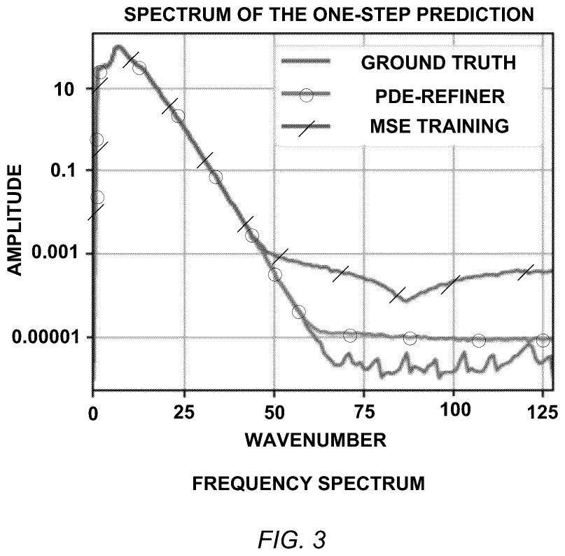

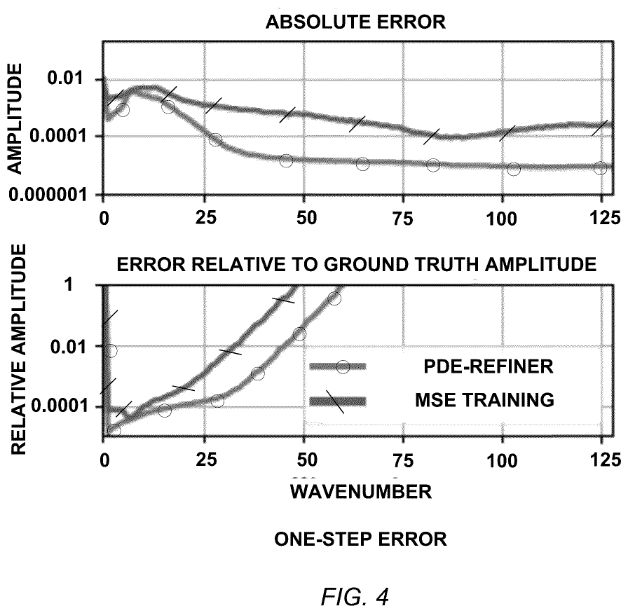

FIG. 3 illustrates, by way of example, a diagram of frequency spectrum over a spatial dimension of the ground truth data and one-step predictions. As can be seen, PDE-Refiner has a more accurate estimate of the higher frequency content than MSE training. Higher frequency content in this instance is at about wavenumber 50 and higher. FIG. 3 shows that the main dynamics of the KS equation are modeled within a frequency band of low wavenumbers (1 to 25). As a result, the primary errors in predicting a one-step solution arise from inaccuracies in modeling the dynamics of these low frequencies. This is evident in FIG. 4, where the error of the MSE-trained model is smallest for this frequency band relative to the ground truth amplitude. Nonetheless, over a long time horizon, the non-linear term uuₓ in the KS equation causes all frequencies to interact, leading to the propagation of high-frequency errors into lower frequencies. Hence, the accurate modeling of frequencies with lower amplitude becomes increasingly important for longer rollout lengths. In the KS equation, this primarily pertains to high frequencies, which the MSE objective significantly neglects.

FIG. 4 illustrates, by way of example, a diagram of errors in terms of absolute error and relative error (relative in terms of ground truth amplitude). The MSE model is only accurate for a small, high-amplitude frequency band, while PDE-Refiner supports a much larger frequency band, leading to rollouts that are accurate for longer amount of time.

Based on the analysis of FIGS. 2-4, one can deduce that in order to obtain long stable rollouts, one can use a neural solver that models all spatial frequencies across the spectrum as accurately as possible. Essentially, an objective can give high amplitude frequencies a higher priority, since these are responsible for the main dynamics of the PDE. However, at the same time, the neural solver should not neglect the non-dominant, low amplitude frequency contributions due to their long-term impact on the dynamics.

Denoising processes have been used elsewhere including in diffusion models. Denoising diffusion probabilistic models (DDPM) randomly sample a noise variable x₀˜N(0, I) and sequentially denoise it until the final prediction, x^{K}, is distributed according to the data:

$${p}_{θ} ( {x}_{0 : K} ) := p ( {x}_{0} ) {\prod }_{k = 0}^{K - 1} {p}_{θ} ( {x}_{k + 1} \vert {x}_{k} ) , \\ {p}_{θ} ( {x}_{k + 1} \vert {x}_{k} ) = N ( {x}_{k + 1} ; {μ}_{θ} ( {x}_{k} , k ) , {\sum }_{θ} ( {x}_{k} , k ) \qquad ( 5 )$$

where K is the number of diffusion steps. For neural PDE solving, one wants p_{θ}(xₖ) to model the distribution over solutions, x_{K}=u(t), while being conditioned on the previous time step u(t−Δt), i.e., p_{θ}(u(t)|u(t−Δt)). Despite the similar use of a denoising process, PDE-Refiner sets itself apart from DDPMs in several key aspects. First, diffusion models typically aim to model diverse, multi-modal distributions like in image generation, while the PDE solutions considered here are deterministic. The deterministic nature of PDEs necessitates extremely accurate predictions with only minuscule errors. PDE Refiner accommodates this by employing an exponentially decreasing noise scheduler with a low minimum noise variance U decreasing much faster and lower than diffusion schedulers.

Second, a goal with PDE-Refiner is not only to model a realistic-looking solution, but also achieve high accuracy across the entire frequency spectrum, which is distinct from a diffusion model that focuses on dominating frequencies. Third, PDE-Refiner can be applied autoregressively to generate long trajectories. Since neural PDE solvers need to be fast to be an attractive surrogate for classical solvers in applications, PDE-Refiner uses far fewer denoising steps in both training and inferences than typical DDPMs. Lastly, PDE-Refiner directly predicts the signal u(t) at the initial step, while DDPMs usually predict the noise residual throughout the entire process. Interestingly, a similar objective to PDE-Refiner is achieved by the v-prediction, which smoothly transitions from predicting the sample u(t) to the additive noise ϵ: v^{k}=\sqrt{1−σₖ²}ϵ−˜ₖu(t). Here, the first step k=0, yields the common MSE prediction objective by setting σ₀=1. With an exponential noise scheduler, the noise variance is commonly much smaller than 1 for k≥1. In these cases, the weight of the noise is almost 1 in the v-prediction.

Similarities between PDE-Refiner and DDPMs indicate that PDE-Refiner has a potential use as a probabilistic latent variable model. Thus, by sampling different noises during the refinement process, PDE-Refiner may provide well-calibrated uncertainties which faithfully indicate when the model might be making errors. Further, implementing PDE-Refiner as a diffusion model with changes, versus implementing it as an explicit denoising process, obtains similar results. The benefit of implementing PDE-Refiner as a diffusion model is the large literature on architecture and hyperparameter studies, as well as available software for diffusion models that can be leveraged for performance. Hence, using a diffusion-based implementation of PDE-Refiner is discussed in the experiments.

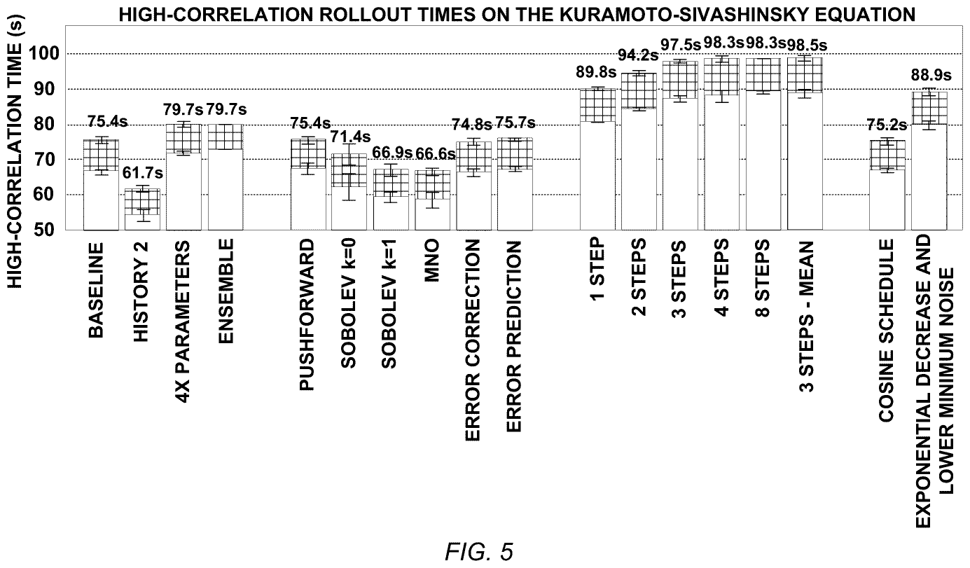

FIG. 5 illustrates, by way of example, a bar graph of correlation time for a variety of PDE solvers. FIG. 5 shows that PDE-Refiner significantly outperforms the baselines and reaches almost 100 seconds of stable rollout. There is a tradeoff between number of refinement steps and performance. When training PDE-Refiner with 1 to 8 refinement steps, the performance improves with more refinement steps, but more steps require more model calls and thus slows down the solver. However, already using a single refinement step improves the rollout performance by 20% over the best baseline, and the gains start to flatten at 3 to 4 refinement steps. Thus, for the remainder of the analysis, focus is on using 3 refinement steps.

The effectiveness of PDE-Refiner on a diverse set of common PDE benchmarks. In one-dimension (1D), the KS equation is studied and compared to several common temporal rollout methods. Further, the robustness of PDE-Refiner to different spatial frequency spectra by varying the viscosity parameter in the KS equation is studied. In 2D, PDE-Refiner is compared to hybrid PDE solvers on a turbulent Kolmogorov flow. A speed comparison between the solvers is provided.

PDE-Refiner and various baselines were evaluated based on the KS 1D equation. A data generation setup uses a mesh of length L discretized uniformly for 256 points with periodic boundaries. For each trajectory, the length L between [0.9·64, 1.1·64] and the time step Δt˜U(0.18, 0.22) were randomly sampled. The initial conditions are sampled from a distribution over truncated Fourier series with random coefficients

$${\{ {A}_{m} , {ℓ}_{m} , {ϕ}_{m} \}}_{m} as {u}_{0} ( x ) = {\sum }_{m = 1}^{10} {A}_{m} sin ( \frac{2 π {ℓ}_{m} x}{L} + {ϕ}_{m} ) .$$

A training dataset with 2048 trajectories of rollout length 140Δt is generated, and tested on 128 trajectories with a duration of 640Δt. As the network architecture, the modern U-Net with hidden size 64 and 3 downsampling layers is used. U-Nets have demonstrated strong performance in both neural PDE solving and diffusion modeling, making it an ideal candidate for PDE-Refiner. A common alternative is the Fourier Neural Operator (FNO). Since FNO layers cut away high frequencies, they perform sub-optimally on predicting the residual noise in PDE-Refiner and DDPMs. Since neural surrogates can operate on larger time steps, the solution is directly predicted at every 4th time step. In other words, to predict u(t), each model takes as input the previous time step u(t−4Δt) and the trajectory parameters L and Δt. Thereby, the models predict the residual between time steps Au(t)=u(t)−u(t−4Δt) instead of u(t) directly, which has shown superior performance at this timescale. As evaluation criteria, the model rollouts' high-correlation time are reported. For this, one can autoregressively rollout the models on the test set and measure the Pearson correlation between the ground truth and the prediction. The time when the average correlation drops below 0.8 and 0.9, respectively, is reported to quantify the time horizon for which the predicted rollouts remain accurate.

PDE-Refiner is compared to three groups of baselines in FIG. 5. The first group are models trained with the one-step MSE error, i.e., predicting Au(t) from u(t−4Δt). The baseline U-Net obtains a high-correlation rollout time of 75 seconds, which corresponds to 94 autoregressive steps. To improve this baseline, incorporating more history information as input, i.e. u(t−4Δt) and u(t−8Δt), improves the one-step prediction but worsens rollout performance.

A problem realized is that the difference between the inputs u(t−4Δt)−u(t−8Δt) is highly correlated with the model's target Au(t), the residual of the next time step. This leads the neural operator to focus on modeling the second-order difference Δu(t)−Au(t−4Δt). As observed in classical solvers, using higher-order differences within an explicit autoregressive scheme is known to deteriorate the rollout stability and introduce exponentially increasing errors over time.

PDE-Refiner's benefit is not just because of having an increased model complexity by training a model with 4 times the parameter count and observe a performance increase performance by only 5%. Similarly, when an ensemble of 5 MSE-trained models is used by averaging their predictions at each rollout step, the ensemble cannot exceed 80 seconds of accurate rollouts.

Another baseline group includes alternative losses and post-processing steps proposed to improve rollout stability. A pushforward trick rolls out the model during training and randomly replaces ground truth inputs with model predictions. This trick does not improve performance in this setting, confirming previous results. While addressing potential input distribution shift, the pushforward trick cannot learn to include the low-amplitude information for accurate long-term predictions, as no gradients are backpropagated through the predicted input for stability reasons. Focusing more on high-frequency information, a Sobolev norm loss maps the prediction error into the frequency domain and weighs all frequencies equally for k=0 and higher frequencies more for k=1. However, focusing on high-frequency information leads to a decreased one-step prediction accuracy for the high-amplitude frequencies, such that the rollout time shortens.

The Markov Neural Operator (MNO) [encourages dissipativity via regularization, but does not improve over the common Sobolev norm losses. The rollout time is reported after correcting the predictions of the MSE models for known invariances in the equation. Mass conservation is ensured by zeroing the mean and set any frequency above 60 to 0, as their amplitude is below float32 precision. This does not improve over the original MSE baselines, showing that the problem is not just an overestimate of the high frequencies, but the accurate modeling of a broader spectrum of frequencies. Finally, to highlight the advantages of the denoising process in PDE-Refiner, a second model is trained to predict another MSE-trained model's errors (Error Prediction). This model quickly overfits on the training dataset and cannot provide gains for unseen trajectories, since it again focuses on the same high-amplitude frequencies.

In an ablation study of PDE-Refiner, a standard denoising diffusion model that is conditioned on the previous time step u(t−4Δt) is considered. When using a common cosine noise schedule, the model performs similar to the MSE baselines. However, with our exponential noise decrease and lower minimum noise level, the diffusion models improve by more than 10 seconds. Using the prediction objective of PDE-Refiner gains yet another performance improvement while reducing the number of sampling steps significantly. Furthermore, one can investigate the probabilistic nature of PDE-Refiner, such as whether it samples single modes under potentially multi-modal uncertainty. For this, one can average 16 samples at each rollout time step (3 steps—Mean in FIG. 5) and find slight performance improvements, indicating that PDE-Refiner mostly predicts single modes.

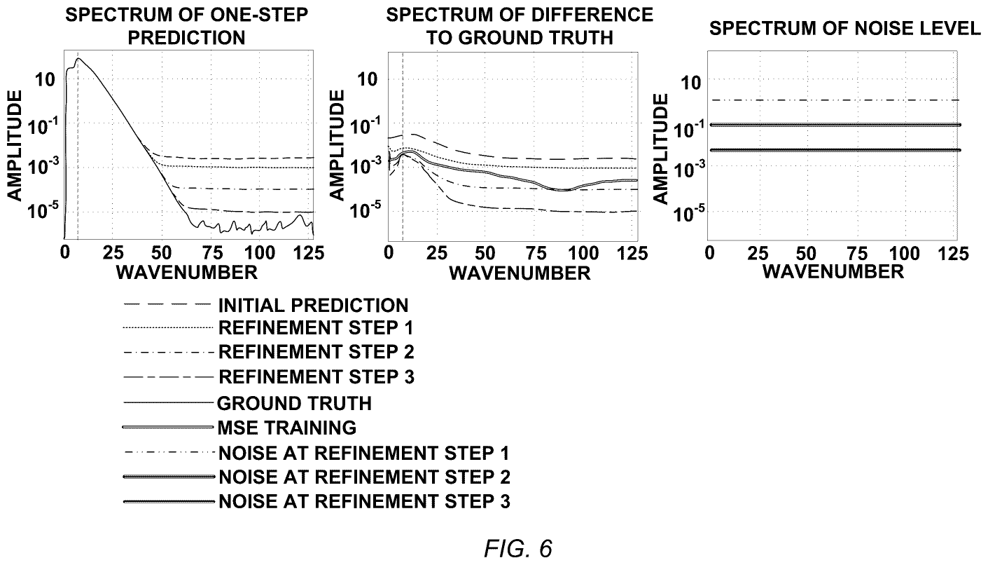

FIG. 6 illustrates, by way of example, graphs of amplitude versus wavenumber for a variety of refinement steps of PDE-Refiner, ground truth, and MSE training. Analyzing a performance difference between the MSE training and PDE-Refiner can be accomplished by comparing their one-step prediction in the frequency domain as in FIG. 6. Similar to the MSE training, the initial prediction of PDE-Refiner has a close-to uniform error pattern across frequencies. While the first refinement step shows an improvement across all frequencies, refinement steps 2 and 3 focus on the low-amplitude frequencies and ignore higher amplitude errors. This can be seen by the error for wavenumber 7, i.e., the frequency with the highest input amplitude, not improving beyond the first refinement step. Moreover, the MSE training obtains almost the identical error rate for this frequency, emphasizing the importance of low-amplitude information. For all other frequencies, PDE-Refiner obtains a much lower loss, showing its improved accuracy on low-amplitude information over the MSE training. Not that PDE-Refiner not only improves the modeling of the high frequencies, but also the lowest frequencies (wavenumber 1-6) with low amplitude.

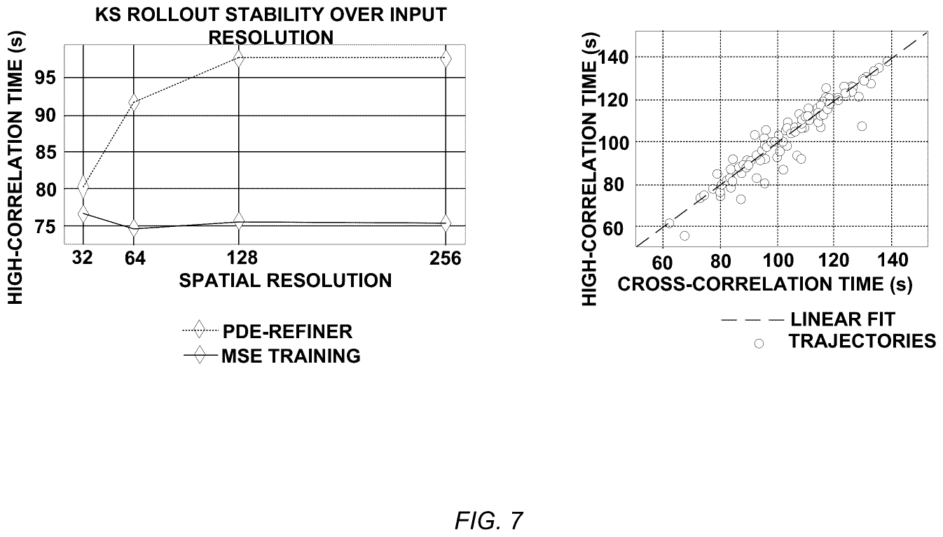

FIG. 7 illustrates, by way of example, respective graphs of high-correlation times for PDE-refiner and MSE training versus time and high-correlation time versus cross-correlation time for PDE-refiner. Capturing high-frequency information can help PDE-Refiner's with performance gains over the MSE baselines by training both models on datasets of subsampled spatial resolution. With lower resolution, fewer frequencies are present in the data and can be modeled. As seen in FIG. 7, MSE models achieve similar rollout times for resolutions between 32 and 256, emphasizing its inability to model high-frequency information. At a resolution of 32, PDE-Refiner achieves similar performance to the MSE baseline due to the missing high-frequency information. However, as resolution increases, PDE-Refiner significantly outperforms the baseline, showcasing its utilization of high-frequency information.

When applying neural PDE solvers in practice, knowing how long the predicted trajectories remain accurate can be important. To estimate PDE-Refiner's predictive uncertainty, one can sample a number of rollouts for each test trajectory by generating different Gaussian noise during the refinement process. The time when the samples diverge from one another can be computed. Divergence here is defined as the cross correlation going below 0.8. FIG. 7 shows that the cross-correlation time as between samples closely aligns with the time over which the rollout remains accurate, leading to a R² coefficient of 0.86 between the two times. Furthermore, the prediction for how long the rollout remains accurate depends strongly on the individual trajectory—PDE-Refiner reliably identifies trajectories that are easy or challenging to roll out from. PDE-Refiner provides more accurate estimates than input modulation, while only requiring one trained model which is different from a model ensemble.

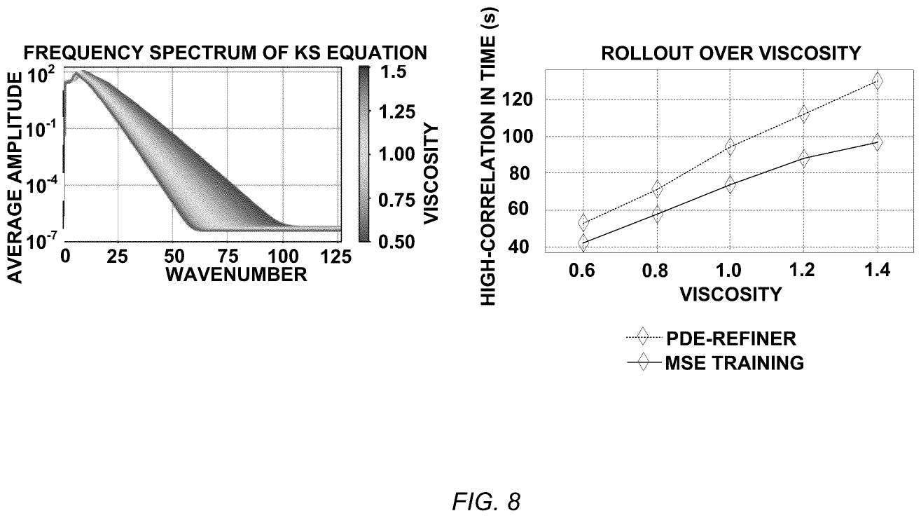

FIG. 8 illustrates, by way of example, respective graphs of average amplitude versus wavenumber and high-correlation time versus viscosity. So far, this discussion has focused on the KS equation with a viscosity term of v=1. Under varying values of v, the KS equation has been shown to develop diverse behaviors and fixed points. This offers an ideal benchmark for evaluating neural surrogate methods on a diverse set of frequency spectra. Experiments included generating 4096 training and 512 test trajectories with the same data generation process as before, except that for each trajectory, v was sampled uniformly between 0.5 and 1.5. This results in the spatial frequency spectrum of FIG. 8, where high frequencies are damped for larger viscosities but amplified for lower viscosities. Thus, an optimal neural PDE solver for this dataset can benefit from working well across a variety of frequency spectra. The remaining experimental setup is as previously discussed, with the viscosity v being added to the conditioning set of the neural operators.

PDE-Refiner is compared to an MSE-trained model by plotting the stable rollout time over viscosities in FIG. 8. Each marker represents trajectories in [v−0.1,v+0.1]. PDE-Refiner is able to achieve a consistent significant improvement over the MSE model across viscosities, verifying that PDE-Refiner works across various frequency spectra and adapts to the given underlying data. Further, both models achieve similar performance to their unconditional counterpart for v=1.0. This again highlights the strength of the U-Net architecture and baselines that are considered herein.

As another common fluid-dynamics benchmark, PDE-Refiner is applied to the 2D Kolmogorov flow, a variant of the incompressible Navier-Stokes flow. The PDE is defined as in Equation 6:

$${\partial }_{t} u + ∇ \cdot ( u ⊗ u ) = v {∇}^{2} u - \frac{1}{p} ∇ p + f \qquad ( 6 )$$

where u: [0, T]×X→ [symbol] ² is the solution, ⊗ the tensor product, v the kinematic viscosity, p the fluid density, p the pressure field, and, finally, f the external forcing. One can set the forcing to f=sin(4y)\hat{x}−0.1u, the density ρ=1, and viscosity v=0.001, which corresponds to a Reynolds number of 1000. The ground truth data is generated using a finite volume-based direct numerical simulation (DNS) method with a time step of Δt=7.0125×10⁻³ and resolution of 2048×2048, and afterwards downscaled to 64×64. To align experiments with previous results, the same dataset of 128 trajectories can be used for training and 16 trajectories for testing.

A modern U-Net is employed as a neural operator 106 backbone. Due to the lower input resolution, one can set σₘᵢₙ²=10⁻³ and use 3 refinement steps in PDE-Refiner. For efficiency, one can predict 16 steps (16Δt) into the future and use the difference Δu=u(t)−u(t−16Δt) as the output target. Besides the MSE objective, PDE-Refiner is compared to FNOs, classical PDE solvers (i.e., DNS) on different resolutions, and state-of-the-art hybrid machine learning solvers, which estimate the convective flux u⊗u via neural networks (NNs). Learned Interpolation (LI) takes the previous solution u(t−Δt) as input to predict u(t), similar to PDE-Refiner. In contrast, the Temporal Stencil Method (TSM) combines information from multiple previous time steps using HiPPO features. PDE Refiner is compared to a Learned Correction model, which corrects the outputs of a classical solver with NNs. For evaluation, the models can be rolled out on the 16 test trajectories and determine the Pearson correlation with the ground truth in terms of the scalar vorticity field ω=∂ₓu_{y}−∂_{y}uₓ. In Table 1, the time until the average correlation across trajectories falls below 0.8 is reported.

TABLE 1
Duration of high correlation (>0.8) on the 2D Kolmogorov
flow. Results for classical PDE solvers and hybrid methods.

| | |
|---|---|
| Method | Time that Correlation >0.8 |

Classical PDE Solvers

| | |
|---|---|
| DNS 64 × 64 | 2.805 |
| DNS 128 × 128 | 3.983 |
| DNS 256 × 256 | 5.386 |
| DNS 512 × 512 | 6.788 |
| DNS 1024 × 1024 | 8.752 |

Hybrid Methods

| | |
|---|---|
| LC - CNN | 6.900 |
| LC - FNO | 7.630 |
| LI - CNN | 7.910 |
| TSM - FNO | 7.798 |
| TSM - CNN | 8.359 |
| TSM - HiPPO | 9.481 |

ML Surrogates

| | |
|---|---|
| MSE Training - FNO | 6.451 ± 0.105 |
| MSE Training - U-Net | 9.663 ± 0.117 |
| PDE-Refiner - U-Net | 10.659 ± 0.092 |

Modern U-Nets outperform FNOs on the 2D domain for long rollouts. The MSE-trained U-Net already surpasses all classical and hybrid PDE solvers. This result highlights the strength of the baselines, and improving upon those poses a significant challenge. Nonetheless, PDE-Refiner manages to provide a substantial gain in performance, remaining accurate 32% longer than the best single-input hybrid method and 10% longer than the best multi-input hybrid methods and MSE model. The plots exhibit a similar behavior of both models. Compared to the KS equation, the Kolmogorov flow has a shorter (due to the resolution) and flatter spatial frequency spectrum. This accounts for the smaller relative gain of PDE-Refiner on the MSE baseline.

The speed of the rollout generation for the test set (16 trajectories of 20 seconds) of three best solvers on an NVIDIA A100 GPU was tested. The MSE U-Net generates the trajectories in 4.04 seconds (±0.01), with PDE-Refiner taking 4 times longer (16.53±0.04 seconds) due to four model calls per step. With that, PDE-Refiner is still faster than the best hybrid solver, TSM, which needs 20.25 seconds (±0.05). In comparison to the ground truth solver at resolution 2048×2048 with 31 minute generation time on GPU, all surrogates provide a significant speedup.

A large-scale analysis of temporal rollout strategies for neural PDE solvers is provided. The analysis identifies that the neglect of low-amplitude information often limits accurate rollout times. To address this issue, PDE-Refiner, which employs an iterative refinement process to accurately and more comprehensively model all frequency components is provided. This approach remains accurate considerably longer during rollouts on three fluid dynamic datasets, effectively overcoming the common pitfall.

PDE-Refiner provides more accurate predicate with increased computation time per prediction. PDE-Refiner is still faster than hybrid and classical solvers. Transformers can benefit from PDE-Refiner as they been shown also suffer from spatial frequency biases for PDEs. The experiments described have only investigated additive Gaussian noise and other noise distributions can be used. Recent blurring diffusion models focus on different spatial frequencies over the sampling process, making them a potentially suitable option for PDE solving as well.

Artificial intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications.

Many NNs are represented as matrices of weights (sometimes called parameters) that correspond to the modeled connections. NNs operate by accepting data into a set of input neurons that often have one or more outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another downstream neuron if the threshold is not exceeded then, generally, the value is not transmitted to a downstream neuron and the synaptic connection remains inactive. The process of weighting and testing continues until an output neuron is reached; the pattern and values of the output neurons constituting the result of the NN processing. The weights of the NNs are usually in the continuous domain, but can be values in the discrete domain.

The optimal operation of most NNs relies on accurate weights. However, NN designers do not generally know which weights will work for a given application. Also, determining weights for discrete weight values is difficult with modern gradient computations. NN designers typically choose a number of layers which may include a number of neurons, pooling, sampling operations, memory units (e.g., long-short term memory (LSTM), gated recurrent unit (GRU), or the like and specific connections between layers including circular connections. A training process may be used to determine appropriate weights. An initial selection of weight values is performed. The initial weights are iteratively improved via backpropagation or other algorithms established in the art.

In some examples, initial weights may be randomly selected. Training data is fed into the NN and results are compared to an objective function that provides an indication of error. The error indication is a measure of how wrong the result of the NN is compared to an expected result. This error is then used to correct the weights. Over many iterations, the weights will collectively converge to encode an approximation of the function from the operational data to a range of values specific to the learning task into the NN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

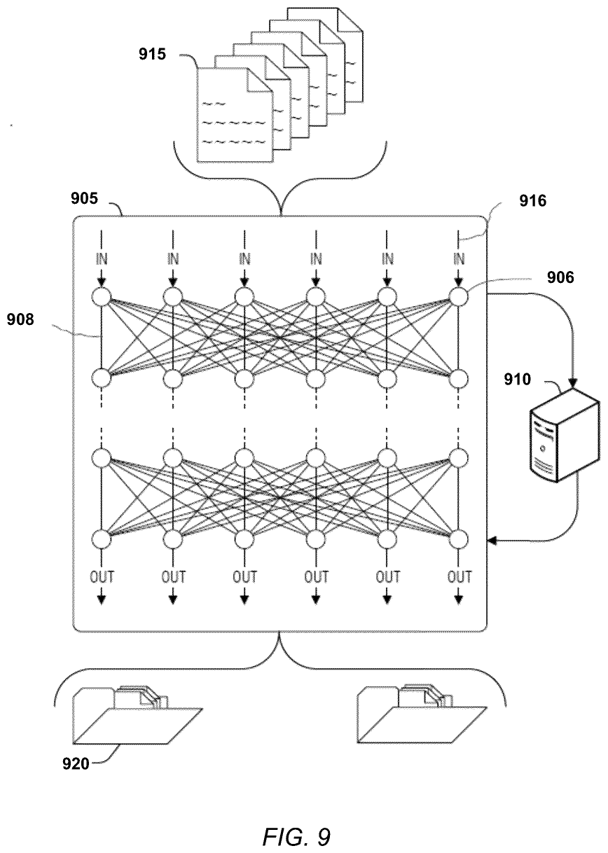

FIG. 9 is a block diagram of an example of an environment including a system for NN training. The system includes an NN 905 that is trained using a processing node 910. The processing node 910 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the NN 905, or even different nodes 907 within layers. Thus, a set of processing nodes 910 is arranged to perform the training of the ANN 905.

The set of processing nodes 910 is arranged to receive a training set 915 for the NN 905. The NN 905 comprises a set of nodes 907 arranged in layers (illustrated as rows of nodes 907) and a set of inter-node weights 908 (e.g., parameters) between nodes in the set of nodes. In an example, the training set 915 is a subset of a complete training set. Here, the subset may enable processing nodes with limited storage resources to participate in training the NN 905.

The training data may include multiple numerical values representative of a domain, such as a word, symbol, other part of speech, or the like. Each value of the training or input 917 to be classified after NN 905 is trained, is provided to a corresponding node 907 in the first layer or input layer of NN 905. The values propagate through the layers and are changed by the objective function.

As noted, the set of processing nodes is arranged to train the NN to create a trained NN. After the NN is trained, data input into the NN will produce valid classifications 920 (e.g., the input data 917 will be assigned into categories), for example. The training performed by the set of processing nodes 907 is iterative. In an example, each iteration of the training the NN 905 is performed independently between layers of the NN 905. Thus, two distinct layers may be processed in parallel by different members of the set of processing nodes. In an example, different layers of the NN 905 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 907 (e.g., neurons) are trained independently. In an example, the nodes are trained on different hardware. The training of the NN 905 can include training to solve a PDE using PDE-Refiner.

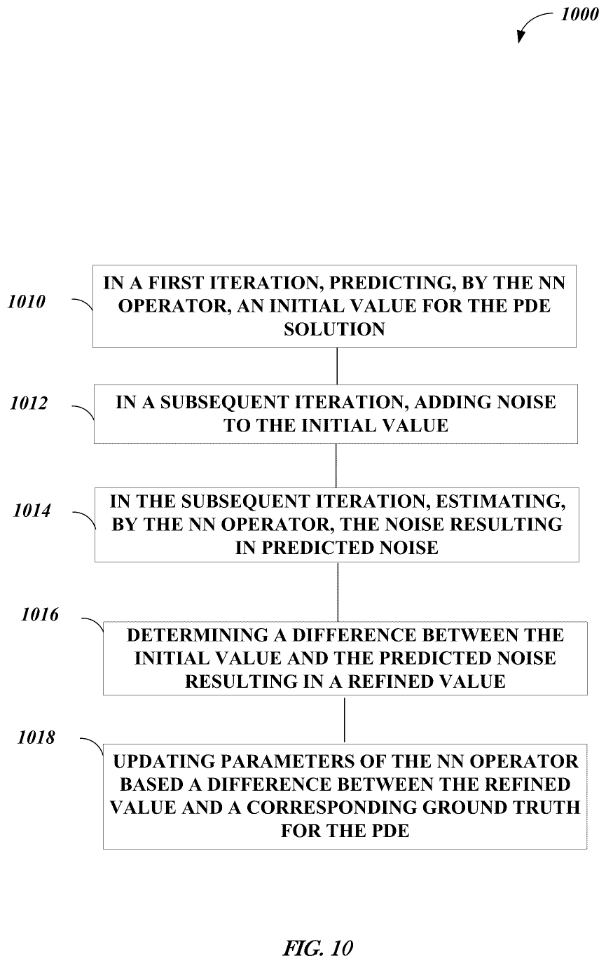

FIG. 10 illustrates, by way of example, a block diagram of an embodiment of a method 1000 for training a PDE solver that includes a neural operator. The method 1000 as illustrated includes training a neural network (NN) operator to estimate a partial differential equation (PDE) solution by: in a first iteration, predicting, by the NN operator, an initial value for the PDE solution, at operation 1010; in a subsequent iteration, adding noise to the initial value, at operation 1012; in the subsequent iteration, estimating, by the NN operator, the noise resulting in predicted noise, at operation 1014; determining a difference between the initial value and the predicted noise resulting in a refined value, at operation 1016; updating parameters of the NN operator based a difference between the refined value and a corresponding ground truth for the PDE, at operation 1018.

The training can include multiple subsequent iterations and for each subsequent iteration training the NN operator includes adding noise to the initial value and predicting, by the NN operator, the noise resulting in predicted noise, determining a difference between the initial value and the predicted noise resulting in a refined value, and updating parameters of the NN based a difference between the refined value and a corresponding ground truth for the PDE. Training the NN operator can include reducing a standard deviation of the noise between consecutive iterations. The NN operation can include a U-Net.

The PDE can model behavior of a fluid, weather, or electricity, or a simulatable physical phenomenon. The noise can conform to a Gaussian distribution, such as by selecting the noise value from a set of noise values that conforms to a Gaussian distribution.

Each subsequent iteration of training can operate by, one or more of: adding noise to the refined value resulting in a noisy refined value, predicting, by the NN operator and based on the noisy refined value, the noise resulting in predicted noise, determining a difference between the noisy refined value and the predicted noise resulting in a further refined value, or updating parameters of the NN based a difference between the further refined value and a corresponding ground truth for the PDE.

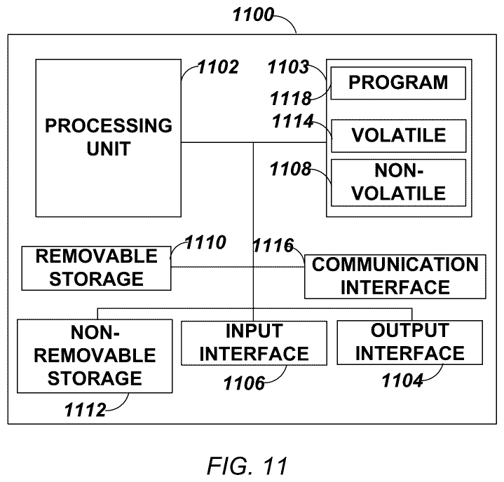

FIG. 11 illustrates, by way of example, a block diagram of an embodiment of a machine 1100 (e.g., a computer system) to implement one or more embodiments. The machine 1100 can implement PDE-Refiner. Any of the neural operator 106, adder 115, subtractor 118, NN 905, processing node 910, method 1000 or a component or operation thereof can include one or more of the components of the machine 1100. One or more of the neural operator 106, adder 115, subtractor 118, NN 905, processing node 910, method 1000, or a component or operations thereof can be implemented, at least in part, using a component of the machine 1100. One example machine 1100 (in the form of a computer), may include a processing unit 1102, memory 1103, removable storage 1110, and non-removable storage 1112. Although the example computing device is illustrated and described as machine 1100, the computing device may be in different forms in different embodiments. For example, the computing device may instead be a smartphone, a tablet, smartwatch, or other computing device including the same or similar elements as illustrated and described regarding FIG. 11. Devices such as smartphones, tablets, and smartwatches are generally collectively referred to as mobile devices. Further, although the various data storage elements are illustrated as part of the machine 1100, the storage may also or alternatively include cloud-based storage accessible via a network, such as the Internet.

Memory 1103 may include volatile memory 1114 and non-volatile memory 1108. The machine 1100 may include—or have access to a computing environment that includes—a variety of computer-readable media, such as volatile memory 1114 and non-volatile memory 1108, removable storage 1110 and non-removable storage 1112. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1100 may include or have access to a computing environment that includes input 1106, output 1104, and a communication connection 1116. Output 1104 may include a display device, such as a touchscreen, that also may serve as an input device. The input 1106 may include one or more of a touchscreen, touchpad, mouse, keyboard, camera, one or more device-specific buttons, one or more sensors integrated within or coupled via wired or wireless data connections to the machine 1100, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1102 (sometimes called processing circuitry) of the machine 1100. A hard drive, CD-ROM, and RAM are some examples of articles including a non-transitory computer-readable medium such as a storage device. For example, a computer program 1118 may be used to cause processing unit 1102 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a method comprising training a neural network (NN) operator to estimate a partial differential equation (PDE) solution by in a first iteration, predicting, by the NN operator, an initial value for the PDE solution, in a subsequent iteration, adding noise to the initial value, in the subsequent iteration, estimating, by the NN operator, the noise resulting in predicted noise, determining a difference between the initial value and the predicted noise resulting in a refined value, and updating parameters of the NN operator based a difference between the refined value and a corresponding ground truth for the PDE.

In Example 2, Example 1 further includes, wherein there are multiple subsequent iterations and for each subsequent iteration training the NN operator includes adding noise to the initial value and predicting, by the NN operator, the noise resulting in predicted noise, determining a difference between the initial value and the predicted noise resulting in a refined value, and updating parameters of the NN based a difference between the refined value and a corresponding ground truth for the PDE.

In Example 3, Example 2 further includes, wherein training the NN operator includes reducing a standard deviation of the noise between consecutive iterations.

In Example 4, at least one of Examples 1-3 further includes, wherein the NN operator includes a U-Net.

In Example 5, at least one of Examples 1-4 further includes, wherein the PDE models behavior of a fluid, weather, or electricity, or a simulatable physical phenomenon.

In Example 6, at least one of Examples 1-5 further includes, wherein the noise conforms to a Gaussian distribution.

In Example 7, at least one of Examples 2-6 further includes, wherein each subsequent iteration includes adding noise to the refined value resulting in a noisy refined value, predicting, by the NN operator and based on the noisy refined value, the noise resulting in predicted noise, determining a difference between the noisy refined value and the predicted noise resulting in a further refined value, and updating parameters of the NN based a difference between the further refined value and a corresponding ground truth for the PDE.

Example 8 includes a system comprising processing circuitry configured to receive a partial differential equation (PDE) solver previously iteratively trained by adding respectively iteratively reduced noise added to input of the PDE solver estimating, by the PDE solver, the noise, and altering parameters of the PDE solver based on the estimated noise, receive data indicating a PDE to be estimated, operate the PDE solver based on the received data, receive a PDE solution estimate from the PDE solver, and a memory configured to receive the PDE solution estimate from the processing circuitry and store the PDE solution estimate or a user interface configured to present the PDE solution estimate.

In Example 9, Example 8 further includes, wherein the PDE solver is trained by: in a first iteration, predicting, by the PDE solver, an initial value for the PDE solution, in a subsequent iteration, adding noise to the initial value, in the subsequent iteration, estimating, by the PDE solver, the noise resulting in predicted noise, determining a difference between the initial value and the predicted noise resulting in a refined value, updating parameters of the PDE solver based a difference between the refined value and a corresponding ground truth for the PDE.

In Example 10, Example 9 further includes, wherein there are multiple subsequent iterations and for each subsequent iteration training the PDE solver includes adding noise to the initial value and predicting, by the PDE solver, the noise resulting in predicted noise, determining a difference between the initial value and the predicted noise resulting in a refined value, and updating parameters of the PDE solver based a difference between the refined value and a corresponding ground truth for the PDE.

In Example 11, Example 10 further includes, wherein training the PDE solver includes reducing a standard deviation of the noise between consecutive iterations.

In Example 12, at least one of Examples 8-11 further includes, wherein the PDE solver includes a U-Net.

In Example 13, at least one of Examples 8-12 further includes, wherein the PDE models behavior of a fluid, weather, or electricity, or a simulatable physical phenomenon.

In Example 14, at least one of Examples 8-13 further includes, wherein the noise conforms to a Gaussian distribution.

In Example 15, at least one of Examples 9-14 further includes, wherein each subsequent iteration operates by adding noise to the refined value resulting in a noisy refined value, predicting, by the PDE solver and based on the noisy refined value, the noise resulting in predicted noise, determining a difference between the noisy refined value and the predicted noise resulting in a further refined value, and updating parameters of the PDE solver based a difference between the further refined value and a corresponding ground truth for the PDE.

Example 16 includes a non-transitory machine-readable medium including instructions that, when executed by a machine, cause the machine to perform operations comprising iteratively training a neural partial differential equation (PDE) solver to estimate a partial differential equation (PDE) solution by in a first iteration, predicting, by the neural PDE solver, an initial value for the PDE solution, in subsequent iterations adding iteratively lower noise to the initial value, in each subsequent iteration of the subsequent iterations, estimating, by the neural PDE solver, added noise resulting in predicted noise, determining a difference between the initial value and the predicted noise resulting in a refined value, updating parameters of neural PDE solver based a difference between the refined value and a corresponding ground truth for the PDE.

In Example 17, Example 16 further includes, wherein training the neural PDE solver includes reducing a standard deviation of the noise between consecutive iterations.

In Example 18, at least one of Examples 16-17 further includes, wherein the neural PDE solver includes a U-Net.

In Example 19, at least one of Examples 16-18 further includes, wherein the PDE models behavior of a fluid, weather, or electricity, or a simulatable physical phenomenon.

In Example 20, at least one of Examples 16-19 further includes, wherein the noise conforms to a Gaussian distribution.

Although a few embodiments have been described in detail above, other modifications are possible. For example, the logic flows depicted in the FIGS. do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
training a neural network (NN) operator to estimate a partial differential equation (PDE) solution by:
in a first iteration, predicting, by the NN operator, an initial value for the PDE solution;
in a subsequent iteration, adding noise to the initial value;
in the subsequent iteration, estimating, by the NN operator, the noise resulting in predicted noise;
determining a difference between the initial value and the predicted noise resulting in a refined value;
updating parameters of the NN operator based a difference between the refined value and a corresponding ground truth for the PDE.

2. The method of claim 1, wherein there are multiple subsequent iterations and for each subsequent iteration training the NN operator includes:
adding noise to the initial value and predicting, by the NN operator, the noise resulting in predicted noise;
determining a difference between the initial value and the predicted noise resulting in a refined value; and
updating parameters of the NN based a difference between the refined value and a corresponding ground truth for the PDE.

3. The method of claim 2, wherein training the NN operator includes reducing a standard deviation of the noise between consecutive iterations.

4. The method of claim 1, wherein the NN operator includes a U-Net.

5. The method of claim 1, wherein the PDE models behavior of a fluid, weather, or electricity, or a simulatable physical phenomenon.

6. The method of claim 1, wherein the noise conforms to a Gaussian distribution.

7. The method of claim 2, wherein each subsequent iteration operates by:
adding noise to the refined value resulting in a noisy refined value;
predicting, by the NN operator and based on the noisy refined value, the noise resulting in predicted noise;
determining a difference between the noisy refined value and the predicted noise resulting in a further refined value; and
updating parameters of the NN based a difference between the further refined value and a corresponding ground truth for the PDE.

8. A system comprising:
processing circuitry configured to:
receive a partial differential equation (PDE) solver previously iteratively trained by adding respectively iteratively reduced noise added to input of the PDE solver, estimating, by the PDE solver, the noise, and altering parameters of the PDE solver based on the estimated noise;
receive data indicating a PDE to be estimated;
operate the PDE solver based on the received data;
receive a PDE solution estimate from the PDE solver; and
a memory configured to receive the PDE solution estimate from the processing circuitry and store the PDE solution estimate.

9. The system of claim 8, wherein the PDE solver is trained by:
in a first iteration, predicting, by the PDE solver, an initial value for the PDE solution;
in a subsequent iteration, adding noise to the initial value;
in the subsequent iteration, estimating, by the PDE solver, the noise resulting in predicted noise;
determining a difference between the initial value and the predicted noise resulting in a refined value;
updating parameters of the PDE solver based a difference between the refined value and a corresponding ground truth for the PDE.

10. The system of claim 9, wherein there are multiple subsequent iterations and for each subsequent iteration training the PDE solver includes:
adding noise to the initial value and predicting, by the PDE solver, the noise resulting in predicted noise;
determining a difference between the initial value and the predicted noise resulting in a refined value; and
updating parameters of the PDE solver based a difference between the refined value and a corresponding ground truth for the PDE.

11. The system of claim 10, wherein training the PDE solver includes reducing a standard deviation of the noise between consecutive iterations.

12. The system of claim 8, wherein the PDE solver includes a U-Net.

13. The system of claim 8, wherein the PDE models behavior of a fluid, weather, or electricity, or a simulatable physical phenomenon.

14. The system of claim 8, wherein the noise conforms to a Gaussian distribution.

15. The system of claim 9, wherein each subsequent iteration operates by:
adding noise to the refined value resulting in a noisy refined value;
predicting, by the PDE solver and based on the noisy refined value, the noise resulting in predicted noise;
determining a difference between the noisy refined value and the predicted noise resulting in a further refined value; and
updating parameters of the PDE solver based on a difference between the further refined value and a corresponding ground truth for the PDE.

16. A non-transitory machine-readable medium including instructions that, when executed by a machine, cause the machine to perform operations comprising:
iteratively training a neural partial differential equation (PDE) solver to estimate a partial differential equation (PDE) solution by:
in a first iteration, predicting, by the neural PDE solver, an initial value for the PDE solution;
in subsequent iterations adding iteratively lower noise to the initial value;
in each subsequent iteration, estimating, by the neural PDE solver, added noise resulting in predicted noise;
determining a difference between the initial value and the predicted noise resulting in a refined value;
updating parameters of neural PDE solver based a difference between the refined value and a corresponding ground truth for the PDE.

17. The non-transitory machine-readable medium of claim 16, wherein training the neural PDE solver includes reducing a standard deviation of the noise between consecutive iterations.

18. The non-transitory machine-readable medium of claim 16, wherein the neural PDE solver includes a U-Net.

19. The non-transitory machine-readable medium of claim 16, wherein the PDE models behavior of a fluid, weather, or electricity, or a simulatable physical phenomenon.

20. The non-transitory machine-readable medium of claim 16, wherein the noise conforms to a Gaussian distribution.
